(19) United States
(12) Patent Application Publication
(10) Pub. No.: US 2014/0327752 A1
(43) Pub. Date: Nov. 6, 2014

(54) VEHICLE OCCUPANCY DETECTION SYSTEM

(71) Applicant: NISSAN NORTH AMERICA, INC., FRANKLIN, TN (US)

(72) Inventor: Hiroshi TSUDA, McLean, VA (US)

(73) Assignee: NISSAN NORTH AMERICA, INC., FRANKLIN, TN (US)

(21) Appl. No.: 13/874,579

(22) Filed: May 1, 2013

(51) Int. Cl. G06K 9/00

(52) U.S. Cl. CPC G06K 9/00838
USPC 348/77

(57) ABSTRACT

A vehicle occupancy detection system comprises a vehicle closure panel detector, an imaging system, and a controller. The vehicle closure panel detector detects a closure panel state including opened and closed states of at least one vehicle closure panel of the vehicle and produces closure panel state signals indicative of the closure panel state. The imaging system captures images of a vehicle compartment of the vehicle and produces image signals. The controller determines that the vehicle closure panel has moved from the opened to closed state based on the closure panel state signals, monitors the image signals received from the imaging system from a time that the vehicle closure panel has moved to the closed state and before it again has moved to the opened state, and stores a occupant count representing a number of occupants in the vehicle compartment as determined based on the image signals.

### BACKGROUND

1. Field of the Invention

The present invention generally relates to a vehicle occupancy detection system. More particularly, the present invention relates to a vehicle occupancy detection system that determines a number of occupants in a vehicle compartment during a time when vehicle closure panels are closed.

2. Background Information

High Occupancy Vehicle (HOV) lanes have been in existence for many years to enable vehicles having a requisite number of passengers (e.g., 2 or more) to travel in the HOV lane, thus increasing the number of passengers that can travel in the HOV lane. However, since the requisite number of passengers is an integer such as 2 or 3, it is difficult to establish lane restrictions that provide the best passenger throughput.

For example, if the requisite number is set too large (e.g., 3 occupants) and not enough vehicles having 3 or more occupants are travelling on the road, then too few vehicles will be able to use the HOV lane. On the other hand, if the requisite number is set too small (e.g., 2 occupants), there can be too many vehicles having 2 or more occupants using the HOV lane, thus making the HOV lane congested.

An attempted solution is the use of High Occupancy and Toll (HOT) lanes. These HOT lanes, which are sometime referred to as Express Lanes, permit access by vehicle having less than the requisite number of occupants for a fee. The fee can be adjusted to attempt to permit an optimum number of vehicles to use the HOT lane at any given time. Accordingly, for an HOT lane system to operate efficiently, it is desirable to monitor the number of occupants in each of the vehicles.

Some techniques for attempting to monitor the number of occupants in vehicles include the use of roadside equipment. However, because vehicles will pass the roadside equipment during a very short period of time, it is not always possible to obtain an accurate reading of the number of occupants. For instance, sun glare can impede the ability of the roadside equipment to see into the passenger compartment of the vehicle, thus making a reading difficult or impossible. Also, since occupants may occasionally lie down in the back seat or reach down to access an object on the floor of the passenger compartment, the roadside equipment may be unable to detect these passengers during the short period of time that the vehicle is passing the roadside equipment.

Other attempts have been made to count the number of passengers that enter and exit the vehicle, and to use this information to keep a tally of the number of occupants. However, this requires that there are no errors in counting a person entering or exiting a vehicle. Also, any errors in counting will not be corrected until the actual number of occupants in the vehicle is otherwise confirmed and adjusted if necessary.

Still further attempts have been to provide a switch in a vehicle that the driver can press to provide an indication that the requisite number of occupants are in the vehicle. However, this technique relies on the honesty of the driver and enforcement in the region of use.

### SUMMARY

In view of the state of the known technology, one aspect of the present invention provides a vehicle occupancy detection system comprising a vehicle closure panel detector, an imaging system, and a controller. The vehicle closure panel detector is configured to detect a closure panel state including an opened state and a closed state of at least one vehicle closure panel of the vehicle and produce closure panel state signals indicative of the closure panel state. The imaging system is configured to capture images of a vehicle compartment of the vehicle and produce image signals. The controller is configured to determine that the vehicle closure panel has moved from the opened state to the closed state based on the closure panel state signals from the vehicle closure panel detector, to monitor the image signals received from the imaging system from a time that the vehicle closure panel has moved to the closed state and before the vehicle closure panel has again moved to the opened state, and to store an occupant count representing a number of occupants in the vehicle compartment as determined based on the image signals.

### BRIEF DESCRIPTION OF THE DRAWINGS

Referring now to the attached drawings which form a part of this original disclosure:

FIG. 1 is a schematic view illustrating an example of components of a vehicle occupancy detection system according to a disclosed embodiment;

FIG. 2 illustrates a forward facing view in a passenger compartment of a vehicle including the vehicle occupancy detection system;

FIG. 3 is a flowchart illustrating exemplary embodiments performed by the vehicle occupancy detection system; and

FIG. 4 illustrates a rearward facing view of the passenger compartment shown in FIG. 2.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

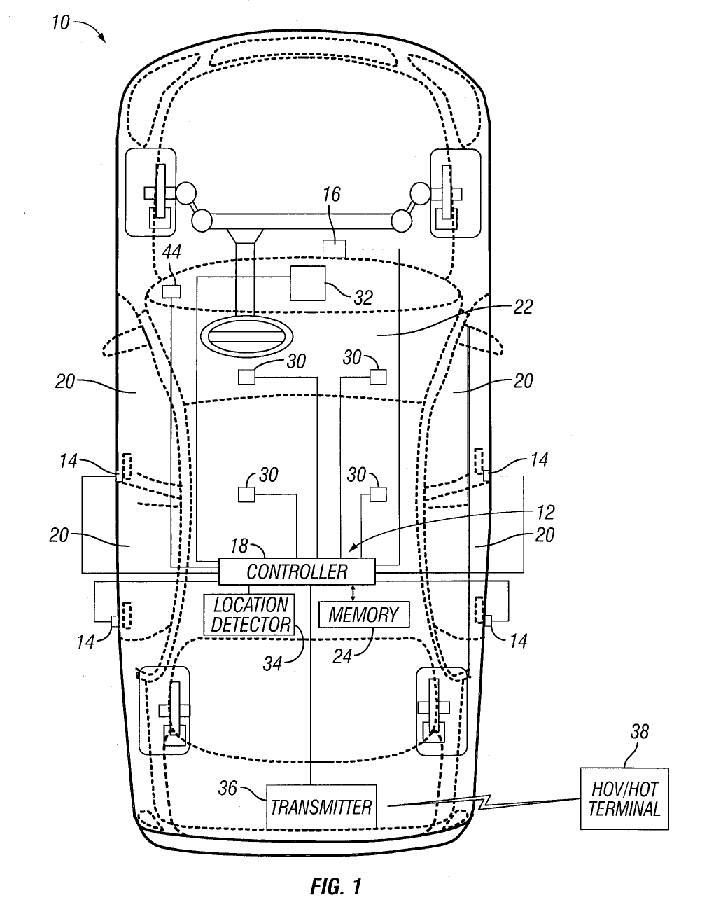

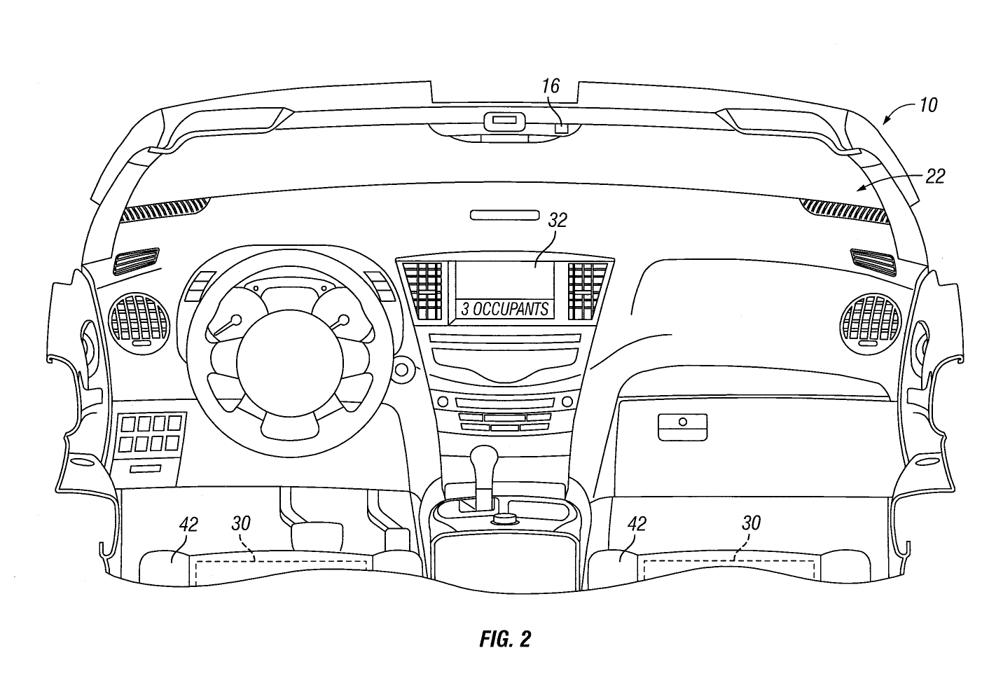

Referring initially to FIGS. 1 and 2, a vehicle 10, such as an automobile, van, truck, SUV or any other type of vehicle, can be equipped with a vehicle occupancy detection system 12 according to a disclosed embodiment. As shown, the vehicle occupancy detection system 12 includes a plurality of vehicle closure panel detectors 14, an imaging system 16 and a controller 18.

The vehicle closure panel detectors 14 can be any type of pressure sensor, optical sensor, and so on which operates to detect a closure panel state including an opened state and a closed state of at least one vehicle closure panel 20 of the vehicle 10. Typically, a vehicle closure panel 20 will refer to a vehicle door. However, a vehicle closure panel 20 can refer to a vehicle window, a vehicle sunroof and any other type of panel which permits access to the passenger compartment 22 of the vehicle 10. Each of the vehicle closure panel detectors 14 produces closure panel state signals indicative of the closure panel state (e.g., an opened state or a closed state) of its respective vehicle closure panel 20. It should also be noted that a closed state of a vehicle closure panel 20 can refer to a condition in which the vehicle closure panel 20 is in a completely closed state (e.g., a shut door, window or sunroof) or in a state which will likely prevent a person from entering or exiting the passenger compartment 22 through the opening that is opened and closed by the vehicle closure panel 20.

As can be appreciated by one skilled in the art, the imaging system 16 can include any suitable type of camera or detector that is capable of capturing images of the passenger compartment (vehicle compartment) 22 of the vehicle 10 and produce image signals. The controller 18 preferably includes a microcomputer with a control program that controls the vehicle occupancy detection system 12 as discussed herein. The controller 18 can also include other conventional components such as an input interface circuit, an output interface circuit, and storage devices such as a ROM (Read Only Memory) device and a RAM (Random Access Memory) device. The RAM and ROM store processing results and control programs that are run by the controller 18. The controller 18 is operatively coupled to the components of the vehicle occupancy detection system 12, and to the components of the vehicle 10 as appropriate, in a conventional manner. It will be apparent to those skilled in the art from this disclosure that the precise structure and algorithms for the controller 18 can be any combination of hardware and software that will carry out the functions of the present invention.

The controller 18 determines that a vehicle closure panel 20 has moved from the opened state to the closed state based on the closure panel state signals from the vehicle closure panel detector 14 associated with that vehicle closure panel 20. The controller 18 also monitors the image signals received from the imaging system 16 from a time that the vehicle closure panel 20 has moved to the closed state and before the vehicle closure panel 20 has again moved to the opened state. The controller 18 can include or be coupled to a memory 24 to store an occupant count representing a number of occupants in the vehicle compartment 22 as determined based on the image signals. Typically, as understood by one skilled in the art, the controller 18 can determine the occupant count after the controller 18 has determined based on the closure panel state signals from all of the vehicle closure panel detectors 14 that all of the vehicle closure panels 20 are in their respective closed state. That is, the controller 18 can monitor the image signals received from the imaging system 16 from a time that all of the vehicle closure panels 20 are determined to be in the closed state and before any of the vehicle closure panels 20 has again moved to the opened state, and to determine the number of occupants in the vehicle compartment 22 based on the image signals. Furthermore, the controller 18 can refrain from determining the number of occupants while any of the vehicle closure panels 20 is in an opened state. Additionally, the controller 18 can erase the memory 24 once a vehicle closure panel detector 14 indicates that one of the vehicle closure panels 20 moved to an opened state to reset the count of the number of occupants until all of the vehicle closure panels 20 return to the closed state and occupant detection begins again.

As further shown in FIGS. 1 and 2, the vehicle occupancy detection system 12 includes at least one detector 30 that operates to detect a characteristic indicative of an occupant and provide occupant detection signals to the controller 18. For example, the detector 30 can be a pressure sensor in each of the seats of the vehicle 10 to detect when a person is occupying a vehicle seat and when a vehicle seat is empty in a manner similar to an occupant detector for use in airbag control systems as known in the art. The detector 30 can also be a seat belt sensor that can detect when a seat belt associated with a vehicle seat has been buckled, this indicating that an occupant may be present in that seat. Accordingly, the controller 18 can determine a second occupant count based on the occupant detection signals provided by the detectors 30 and compare the stored occupant count with the second occupant count to verify the number of occupants in the vehicle 10.

Also, as shown in FIGS. 1 and 2, the vehicle occupancy detection system 12 can include a visual display system 32, such as a navigation display in the vehicle 10. The controller 18 can control the visual display system 32 to continually display the occupant count while the occupancy detection system 12 is active.

In addition, the vehicle occupancy detection system 12 can include a vehicle location detector 34, such as a GPS system or any other suitable system which determines the location of the vehicle 10 with respect to a high occupancy vehicle travel lane and produces a location signal indicative of the location of the vehicle 10. The vehicle occupancy detection system 12 further includes a transmitter 36 that is controlled by the controller 18 to transmit a vehicle identifier along with information representing the occupant count to a location remote from the vehicle 10 while the location signal indicates the vehicle 10 is in the high occupancy vehicle (or HOT) travel lane. The remote location can include, for example, a terminal 38 that is associated with a toll system to wirelessly receive signals from the vehicles 10 using the HOV or HOT travel lane. It is also contemplated that the terminal 38 can indicate to the location detector 34 whether the vehicle 10 is in the HOV or HOT lane, and the vehicle occupancy detection system 12 can become idle or inactive while the vehicle is outside of the HOV or HOT lane, and active while the vehicle is in the HOV or HOT lane. Additionally, the controller 18 can control the display 32 to provide an indication of the location of the vehicle 10 being in the HOV or HOT lane and/or the passenger count while the location detector 34 detects the vehicle 10 is in the HOV or HOT lane.

The information received by the terminal 38 from the transmitter 36 can be used in several ways. Since the occupant count information is accompanied by a vehicle identifier, the entity in control of the HOV or HOT lane may analyze the information collected by the terminal 38 and send a bill to the owner of vehicle 10 for tolls due when the vehicle 10 is using the HOT lane without the required number of occupants, or a ticket for an HOV lane use violation when using the HOV lane without the required number of occupants. Additionally, if the HOV or HOT lane is gated to prohibit entering the HOV or HOT lane without the required number of occupants, the terminal 38 can analyze the information and raise the gate for vehicles that have the required number of occupants.

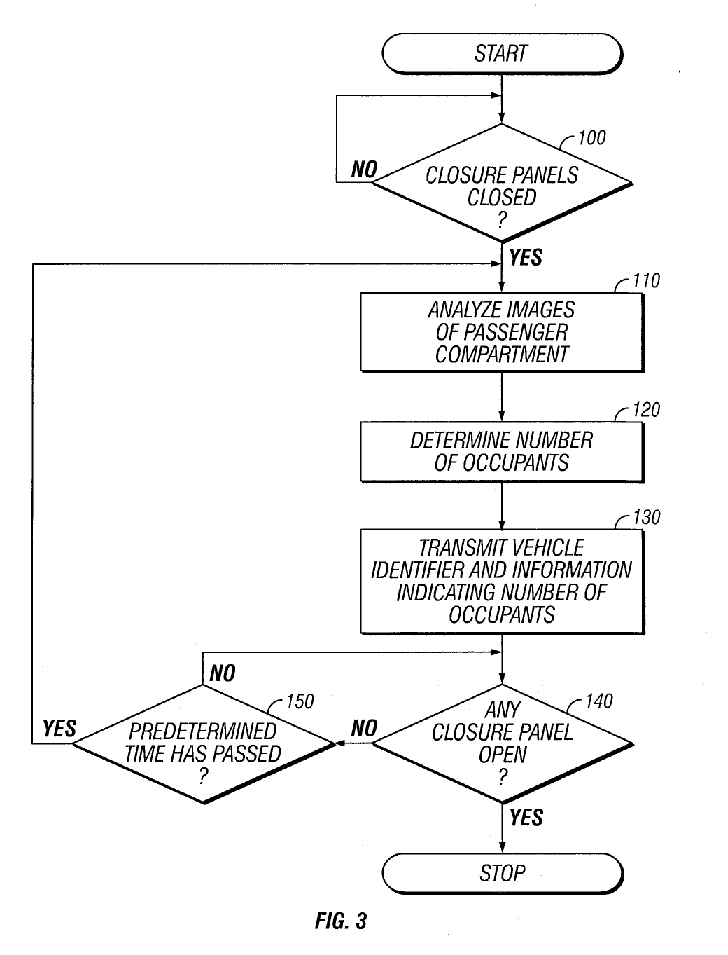

The operations described above will now be discussed in more detail with reference to the flowchart in FIG. 3. After the processing begins, in step 100 the controller 18 determines based on the signals from the vehicle closure panel detectors 14 whether all of the vehicle closure panels 20 are in their respective closed state. If the controller 18 determines that any of the vehicle closure panels 20 are not in their respective closed state, the controller 18 can refrain from attempting to determine the number of occupants and the processing can repeat as shown. Once the controller 18 determines that all of the vehicle closure panel detectors 14 are in their respective closed state, the processing continues to step 110 where the controller 18 can analyze the images being provided by the imaging system 16.

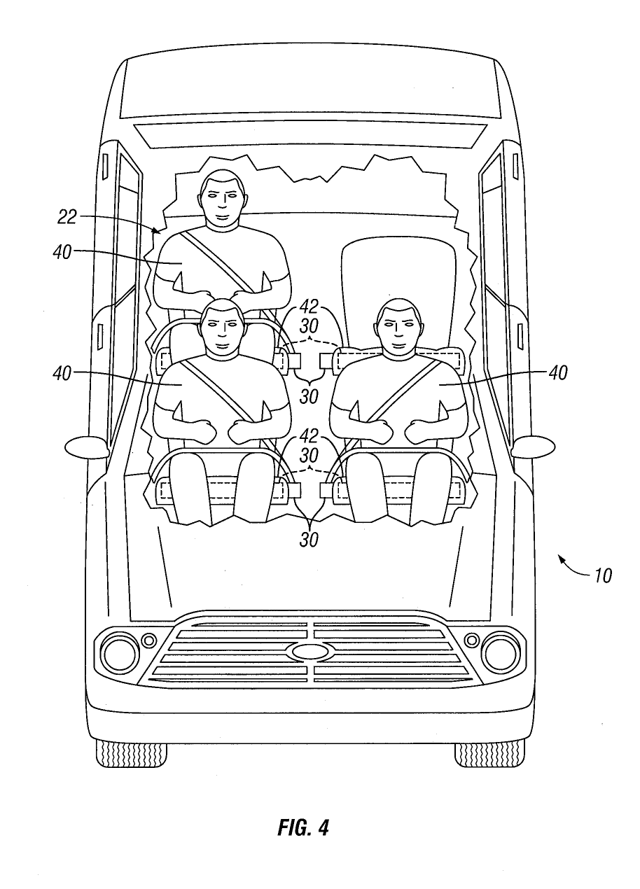

The controller 18 can then determine the number of occupants in the vehicle compartment 22 based on the signals from the imaging system 16 in step 120. That is, as shown in FIG. 4, the controller 18 can distinguish based on the signals whether there is a human occupant 40 in a vehicle seat 42, or whether the vehicle seat is empty or occupied by another object or non-human occupant such as a pet. The controller 18 can perform any type of processing, such as facial recognition processing and so on, to determine whether the object occupying a vehicle seat 42 is a human 40. In addition, as discussed above, the controller 18 can verify the accuracy of the determined number of occupants based on signals provided by, for example, detectors 30.

In step 130, the controller 18 can control the transmitter 34 to transmit the vehicle identifier and information representing the number of occupants in the passenger compartment as determined in step 120. The controller 18 can then determine in step 140 whether any of the vehicle closure panels 20 has moved to an open state. If any of the vehicle closure panels 20 has moved to an open state, the processing can end as shown.

One example of a vehicle occupancy detection system 12 includes monitoring sunroof or windows by the vehicle closure panel detectors 14 in addition to the vehicle doors. In this example, a speed sensor 44 may be used to detect whether the vehicle 10 is travelling above a predetermined speed while detecting the number of occupants. That way, even when the occupants 40 desire to use the sunroof or windows in an opened state, the vehicle occupancy detection system 12 can continue to count the occupants while the vehicle 10 is travelling above the predetermined speed, as it may be assumed that no occupants 40 will be attempting to exit or enter the vehicle 10 through the sunroof or window in that situation.

However, as long as all of the vehicle closure panels 20 remain in their closed state, the processing can continue to step 150 where the controller 18 determines whether a predetermined amount of time has passed. If the predetermined amount of time has not passed, the processing can return to step 140 and repeat as discussed above. However, if the predetermined amount of time has passed, the processing can return from step 150 to step 120 and repeat as discussed above. In this event, the controller 18 can update the determined number of occupants based on the image signals captured at this new point in time to provide a more reliable occupant count than would be achieved by counting the occupants at only a single point in time.

Table 1 below illustrates an example of the number of occupants that can be detected at the different points in time.

| | | Most Probable | |
|---|---|---|---|
| | Number of | Number of | Maximum Number |
| Time | Detected Occupants | Occupants | of Occupants |
| T1 | 2 | 2 | 2 |
| T2 | 3 | 2 | 3 |
| T3 | 3 | 3 | 3 |
| T4 | 2 | 3 | 3 |
| T5 | 4 | 3 | 4 |
| T6 | 3 | 3 | 4 |

Accordingly, in step 120, the controller 18 can further determine the number of occupants by determining a respective number of occupants in the vehicle compartment 22 at multiple different times based on the image signals from the time that the vehicle closure panels 20 have moved to the closed state and before any of the vehicle closure panels 20 has again moved to the opened state. The processing then repeats steps 130 through 150 as discussed above. Hence, the controller 18 can thus determine the most probable number of occupants based on the respective number of occupants determined at each of the different times, and can set the occupant count equal to the most probable number of occupants determined. The controller 18 can perform any known type of statistical analysis to determine the most probable number of occupants.

Alternatively, in step 130, the controller 18 can determine the number of occupants by determining a respective number of occupants in the vehicle compartment 22 at the different times based on the image signals from the time that all of the vehicle closure panels 20 have moved to their respective closed state and before any of the vehicle closure panels 20 has again moved to its respective opened state, determine a maximum number of occupants based on the respective number of occupants determined at each of the different times, and set the occupant count equal to the maximum number of occupants determined. Moreover, as discussed above, the controller 18 can ascertain an accuracy in the number of occupants determined by determining a respective number of occupants in the vehicle compartment 22 at different times based on the image signals from the time that all of the vehicle closure panels 20 have moved to their respective closed state and before any of the vehicle closure panels 20 has again moved to its respective opened state, and determining whether the respective number of occupants are equal at each of the different times. If the number of occupants are equal at several of the different times, the controller 18 can conclude that the determined number of occupants is accurate.

Accordingly, as can be appreciated from the above, the vehicle occupancy detection system 12 can accurately and effectively determine the number of occupants in a vehicle compartment 22.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also, the term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle occupancy detection system comprising:
a vehicle closure panel detector configured to detect a closure panel state including an opened state and a closed state of at least one vehicle closure panel of the vehicle and produce closure panel state signals indicative of the closure panel state;
an imaging system configured to capture images of a vehicle compartment of the vehicle and produce image signals; and
a controller configured to determine that the vehicle closure panel has moved from the opened state to the closed state based on the closure panel state signals from the vehicle closure panel detector, to monitor the image signals received from the imaging system from a time that the vehicle closure panel has moved to the closed state and before the vehicle closure panel has again moved to the opened state, and to store a occupant count representing a number of occupants in the vehicle compartment as determined based on the image signals.

2. The vehicle occupancy detection system according to claim 1, further comprising
a detector configured to detect a characteristic indicative of an occupant and provide occupant detection signals, the controller being further configured to determine a second occupant count based on the occupant detection signals and compare the stored occupant count with the second occupant count to verify the number of occupants in the vehicle.

3. The vehicle occupancy detection system according to claim 1, wherein
the controller is configured to determine the number of occupants by determining a respective number of occupants in the vehicle compartment at different times based on the image signals from the time that the vehicle closure panel has moved to the closed state and before the vehicle closure panel has again moved to the opened state, determining a most probable number of occupants based on the respective number of occupants determined at each of the different times, and setting the occupant count equal to the most probable number of occupants determined.

4. The vehicle occupancy detection system according to claim 1, wherein
the controller is configured to determine the number of occupants by determining a respective number of occupants in the vehicle compartment at different times based on the image signals from the time that the vehicle closure panel has moved to the closed state and before the vehicle closure panel has again moved to the opened state, determining a maximum number of occupants based on the respective number of occupants determined at each of the different times, and setting the occupant count equal to the maximum number of occupants determined.

5. The vehicle occupancy detection system according to claim 1, wherein
the controller is further configured to ascertain an accuracy in the number of occupants determined by determining a respective number of occupants in the vehicle compartment at different times based on the image signals from the time that the vehicle closure panel has moved to the closed state and before the vehicle closure panel has again moved to the opened state and determining whether the respective number of occupants are equal at each of the different times.

6. The vehicle occupancy detection system according to claim 1, further comprising
a vehicle location detector configured to determine the location of the vehicle with respect to a high occupancy vehicle travel lane and produce a location signal indicative of the location of the vehicle; and
a transmitter configured to transmit information representing the occupant count to a location remote from the vehicle while the location signal indicates the vehicle is in the high occupancy vehicle travel lane.

7. The vehicle occupancy detection system according to claim 1, further comprising
a visual display system, wherein the controller controls the visual display system to continually display the occupant count.

8. The vehicle occupancy detection system according to claim 1, wherein
the controller is configured to refrain from determining the number of occupants while the vehicle closure panel is in the opened state.

9. The vehicle occupancy detection system according to claim 1, wherein
the vehicle closure panel detector configured to detect a closure panel state including an opened state and a closed state of all of the vehicle closure panels of the vehicle; and
the controller is configured to determine that all of the vehicle closure panels are in the closed state based on the closure panel state signals from the vehicle closure panel detector, to monitor the image signals received from the imaging system from a time that all of the vehicle closure panels are determined to be in the closed state and before any of the vehicle closure panels has again moved to the opened state, and to determine the number of occupants in the vehicle compartment based on the image signals.

10. The vehicle occupancy detection system according to claim 9, wherein
the controller is configured to refrain from determining the number of occupants while any of the vehicle closure panels is in the opened state.

11. A vehicle occupancy detection method comprising:
operating a vehicle closure panel detector to detect a closure panel state including an opened state and a closed state of at least one vehicle closure panel of the vehicle and produce closure panel state signals indicative of the closure panel state;
operating an imaging system to capture images of a vehicle compartment of the vehicle and produce image signals; and
operating a controller to determine that the vehicle closure panel has moved from the opened state to the closed state based on the closure panel state signals from the vehicle closure panel detector, to monitor the image signals received from the imaging system from a time that the vehicle closure panel has moved to the closed state and before the vehicle closure panel has again moved to the opened state, and to store a occupant count representing a number of occupants in the vehicle compartment as determined based on the image signals.

12. The vehicle occupancy detection method according to claim 11, further comprising
operating a detector to detect a characteristic indicative of an occupant and provide occupant detection signals; and
operating the controller to determine a second occupant count based on the occupant detection signals and compare the stored occupant count with the second occupant count to verify the number of occupants in the vehicle.

13. The vehicle occupancy detection method according to claim 11, further comprising
operating the controller to identify a respective number of occupants in the vehicle compartment at different times based on the image signals from the time that the vehicle closure panel has moved to the closed state and before the vehicle closure panel has again moved to the open state; and
the operating of the controller to determine the number of occupants includes operating the controller to determine a most probable number of occupants based on the respective number of occupants determined at the different times and set the number of occupants equal to the most probable number of occupants.

14. The vehicle occupancy detection method according to claim 11, further comprising
operating the controller to identify a respective number of occupants in the vehicle compartment at different times based on the image signals from the time that the vehicle closure panel has moved to the closed state and before the vehicle closure panel has again moved to the open state; and
the operating of the controller to determine the number of occupants includes operating the controller to set the number of occupants equal to a maximum number of occupants determined to be in the vehicle compartment at any of the different times.

15. The vehicle occupancy detection method according to claim 11, further comprising
operating the controller to ascertain an accuracy in the number of occupants by determining a respective number of occupants in the vehicle compartment at different times based on the image signals from the time that the vehicle closure panel has moved to the closed state and before the vehicle closure panel has again moved to the open state and determining whether the respective number of occupants are equal at the different times.

16. The vehicle occupancy detection method according to claim 11, further comprising
operating a vehicle location detector to determine the location of the vehicle with respect to a high occupancy vehicle travel lane and produce a location signal indicative of the location of the vehicle; and
operating a transmitter to transmit information representing the occupant count to a location remote from the vehicle while the location signal indicates the vehicle is in the high occupancy vehicle travel lane.

17. The vehicle occupancy detection method according to claim 16, wherein
the transmitting includes transmitting the information in a format for receipt by a receiver associated with a toll collection system at the location remote from the vehicle.

18. The vehicle occupancy detection method according to claim 11, further comprising
operating the controller to refrain from determining the number of occupants while the vehicle closure panel is in the open state.

19. The vehicle occupancy detection method according to claim 11, wherein
the vehicle closure panel determining includes monitoring opening and closing of all of the vehicle closure panels of the vehicle; and
the operating of the controller to determine the number of occupants includes operating the controller to determine a number of occupants in the vehicle compartment based on the image signals received from the imaging system from a time that all of the vehicle closure panels have moved to the closed state and before any of the vehicle closure panels has again moved to the open state.

20. The vehicle occupancy detection method according to claim 19, further comprising
operating the controller to refrain from determining the number of occupants while any of the vehicle closure panels is in the open state.
